(19) United States
(12) Patent Application Publication
(10) Pub. No.: US 2024/0127571 A1
(43) Pub. Date: Apr. 18, 2024

(54) VIRTUAL-GAUGE-BASED PLANT MONITORING SYSTEM AND METHOD

(71) Applicant: GAONPLATFORM INC., Daejeon (KR)

(72) Inventor: Man Young CHO, Sejong (KR)

(21) Appl. No.: 18/242,528

(22) Filed: Sep. 6, 2023

Related U.S. Application Data
(63) Continuation of application No. PCT/KR22/19866, filed on Dec. 8, 2022.

(30) Foreign Application Priority Data
Oct. 17, 2022 (KR) 10-2022-0133009

(51) Int. Cl. G06V 10/20; G06V 10/25

(52) U.S. Cl. CPC G06V 10/255; G06V 10/25

(57) ABSTRACT

A virtual-gauge-based plant monitoring system includes: a photographing part provided at a plurality of locations inside a plant and configured to photograph at least one plant facility; an image analysis part configured to receive image data obtained by the photographing part, identify a measurement device of the plant facility from the received image data to extract a measurement value, and generate a measurement data packet transmittable to a non-secure area, the measurement data packet including the extracted measurement value; and a virtual gauge visualization part configured to receive the measurement data packet in the non-secure area, visualize a virtual gauge corresponding to the measurement device of the plant facility on the basis of the measurement data packet, and display the measurement value in real time on the visualized virtual gauge.

### CROSS REFERENCE TO RELATED APPLICATION

This application is a Bypass Continuation of International Application No. PCT/KR2022/019866, filed on Dec. 8, 2022, and claims priority from and the benefit of Korean Patent Application No. 10-2022-0133009, filed on Oct. 17, 2022, each of which is incorporated by reference for all purposes as if fully set forth herein.

### BACKGROUND

### Field

Embodiments of the invention relate generally to a virtual-gauge-based plant monitoring system and method.

### Discussion of the Background

In general, plant facilities for manufacturing, assembly, storage, and management are built in a plant, and the various plant facilities are provided with measurement devices such as gauge boards that display current states or measurement values.

Herein, the above-described plant means various plant institutions including a process plant, and in addition, may include institutions, such as national security institutions, national defense institutions, and smart factories, which need to be equipped with measurement devices, such as a gauge board, to monitor states or measurement values.

In such a plant, it is necessary to always monitor whether the plant facilities operate normally. Due to a large number of plant facilities and various measurement devices, the plant facilities are equipped with various sensors and selective control is performed by monitoring sensor signals and selectively supervising only a particular plant facility in an all-source situation room.

In the meantime, in the conventional plant, if a plant facility has a problem with a sensor signal, a manager can move to the plant facility in person and checks the measurement device, but cannot monitor the states or measurement values of all the plant facilities simultaneously. Unfortunately, a lot of time and effort are consumed for integrated management of the plant facilities.

In addition, closed-circuit television (CCTV) is installed for internal supervision in the conventional plant, but most CCTV is installed for checking the overall state of the area where facilities are located, making it difficult to identify analog gauges. Therefore, image data of the CCTV cannot be used for monitoring the measurement devices of the plant facilities.

The above information disclosed in this Background section is only for understanding of the background of the inventive concepts, and, therefore, it may contain information that does not constitute prior art.

### SUMMARY

The present disclosure has been made keeping in mind the above problems occurring in the related art, and the present disclosure is directed to providing a virtual-gauge-based plant monitoring system and method that are capable of performing integrated management of plant facilities by using image data of CCTV installed in a plant.

Additional features of the inventive concepts will be set forth in the description which follows, and in part will be apparent from the description, or may be learned by practice of the inventive concepts.

According to an aspect of the invention, a virtual-gauge-based plant monitoring system includes: a photographing part provided at a plurality of locations inside a plant and configured to photograph at least one plant facility; an image analysis part configured to receive image data obtained by the photographing part, identify a measurement device of the plant facility from the received image data to extract a measurement value, and generate a measurement data packet transmittable to a non-secure area, the measurement data packet including the extracted measurement value; and a virtual gauge visualisation part configured to receive the measurement data packet in the non-secure area, visualize a virtual gauge corresponding to the measurement device of the plant facility on the basis of the measurement data packet, and display the measurement value in real time on the visualized virtual gauge.

The system may further include a monitoring part configured to monitor the measurement value displayed on the virtual gauge and output an alarm when the measurement value is out of a preset normal range.

The image analysis part may be configured to convert the image data to a hue saturation value (HSV) image, set a region of interest (ROI) on the basis of at least one structural feature selected from a group of a color, a pattern, a size, and a shape, and detect an object corresponding to the measurement device within the region of interest.

The image analysis part may be configured to identify a type of the measurement device from an image of a detected object to extract the measurement value, and insert identification information on the type of the measurement device and information on the measurement value in generating the measurement data packet.

The virtual gauge visualization part may be configured to identify a type of the measurement device on the basis of identification information included in the measurement data packet, and load and visualize a 3D model corresponding to the identified measurement device as the virtual gauge.

The virtual gauge visualisation part may be configured to change, each time the measurement data packet is received and the measurement value is updated, a pointer on the virtual gauge and an object corresponding to a gauge board to locations or numerical values according to the measurement value of the measurement data packet, and display the locations or the numerical values.

In the measurement data packet, location information of the plant facility or the photographing part and identification information of the measurement device may be inserted in a header area, and information on time when the plant facility is photographed and information on the measurement value may be inserted in a body area.

According to another aspect of the invention, a virtual-gauge-based plant monitoring method performed in a virtual-gauge-based plant monitoring system, the method includes: photographing, in a photographing step, at least one plant facility at a plurality of locations inside a plant; receiving, in an extracting step, image data obtained by performing photographing, and identifying a measurement device of the plant facility from the received image data to extract a measurement value; generating, in a packet generating step, a measurement data packet transmittable to a non-secure area, the measurement data packet including the extracted measurement value; receiving, in a visualizing step, the measurement data packet in the non-secure area, and visualizing a virtual gauge corresponding to the measurement device of the plant facility on the basis of the measurement data packet; and displaying, in a measurement value displaying step, the measurement value on the visualized virtual gauge in real time.

The method may further include monitoring, in a monitoring step, the measurement value displayed on the virtual gauge and outputting an alarm when the measurement value is out of a preset normal range.

In the extracting step, the image data may be converted to a Hue Saturation Value (HSV) image, and a region of interest (ROI) may be set on the basis of at least one structural feature selected from a group of a color, a pattern, a size, and a shape, and an object corresponding to the measurement device may be detected within the region of interest.

In the packet generating step, when a type of the measurement device and the measurement value are extracted from an image of a detected object, identification information on the type of the measurement device and information on the measurement value may be inserted in generating the measurement data packet.

In the visualizing step, a type of the measurement device may be identified on the basis of identification information included in the measurement data packet, and a 3D model corresponding to the identified measurement device may be loaded and visualized as the virtual gauge.

In the measurement value displaying step, each time the measurement data packet is received and the measurement value is updated, a pointer on the virtual gauge and an object corresponding to a gauge board may be changed to locations or numerical values according to the measurement value of the measurement data packet and the locations or the numerical values may be displayed.

In the measurement data packet, location information of the plant facility or the photographing part and identification information of the measurement device may be inserted in a header area, and information on time when the plant facility is photographed and information on the measurement value may be inserted in a body area.

According to the present disclosure, a measurement data packet transmittable to the non-secure area is generated from image data obtained by photographing a plant facility and transmitted to the non-secure area, and in the non-secure area, the measurement data packet is used to visualize a virtual gauge corresponding to a measurement device of the plant facility, whereby through virtual gauges visualized by the server in the non-secure area, the states or measurement values of all the plant facilities can be simultaneously monitored.

In addition, according to the present disclosure, image data in the secure area is converted into a measurement data packet and the measurement data packet can be transmitted to the non-secure area, whereby while complying a security policy that image data of CCTV cannot be transmitted or linked to the non-secure area, the image data of the CCTV can be used for monitoring the plant facilities.

It is to be understood that both the foregoing general description and the following detailed description are illustrative and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate illustrative embodiments of the invention, and together with the description serve to explain the inventive concepts.

FIG. 1 is a diagram illustrating a virtual-gauge-based plant monitoring system according to an embodiment of the present disclosure.

FIG. 2 is a block diagram illustrating a detailed configuration of the virtual-gauge-based plant monitoring system.

FIG. 3 is a block diagram illustrating a process of transmitting a measurement data packet to a non-secure area in the virtual-gauge-based plant monitoring system.

FIG. 4 is a diagram illustrating a virtual-gauge-based plant monitoring method according to an embodiment of the present disclosure.

### DETAILED DESCRIPTION

In the following description, for the purposes of explanation, numerous specific details are set forth in order to provide a thorough understanding of various embodiments or implementations of the invention. As used herein “embodiments” and “implementations” are interchangeable words that are non-limiting examples of devices or methods employing one or more of the inventive concepts disclosed herein. It is apparent, however, that various embodiments may be practiced without these specific details or with one or more equivalent arrangements. In other instances, well-known structures and devices are shown in block diagram form in order to avoid unnecessarily obscuring various embodiments. Further, various embodiments may be different, but do not have to be exclusive. For example, specific shapes, configurations, and characteristics of an embodiment may be used or implemented in another embodiment without departing from the inventive concepts.

Unless otherwise specified, the illustrated embodiments are to be understood as providing illustrative features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the D1-axis, the D2-axis, and the D3-axis are not limited to three axes of a rectangular coordinate system, such as the x, y, and z-axes, and may be interpreted in a broader sense. For example, the D1-axis, the D2-axis, and the D3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

Specific details of the present disclosure described herein are provided to facilitate a general understanding of the present disclosure, and it will be apparent to those skilled in the art that the present disclosure can be easily embodied without these specific details or by variations thereof.

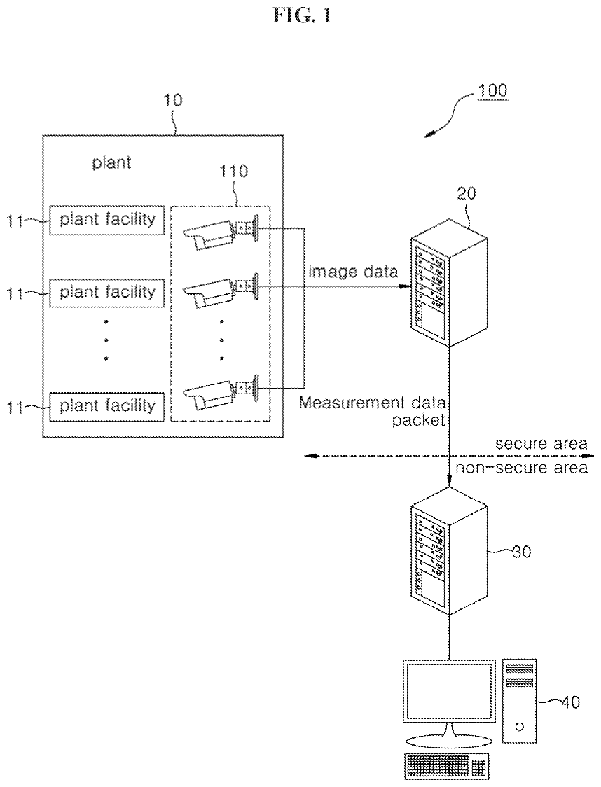

Hereinafter, preferred embodiments of the present disclosure will be described in detail with reference to accompanying FIGS. 1 to 4, focusing on the parts necessary to understand the operation and action according to the present disclosure.

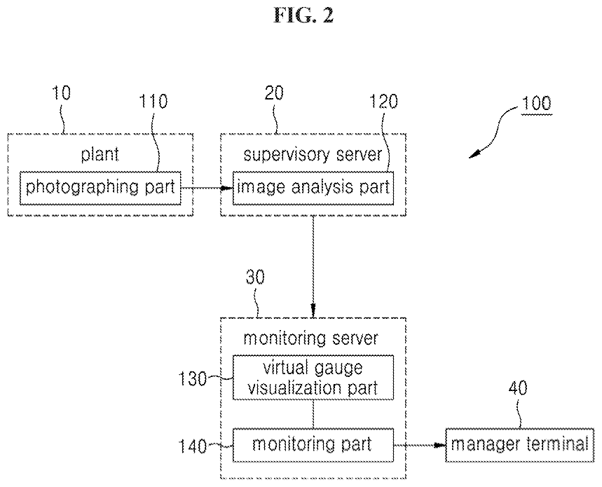

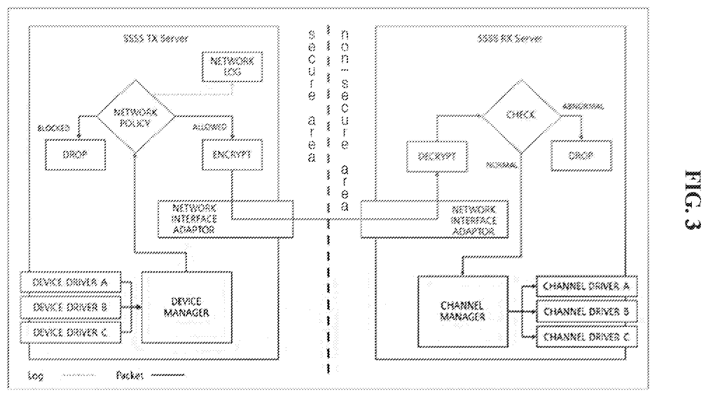

FIG. 1 is a diagram illustrating a virtual-gauge-based plant monitoring system according to an embodiment of the present disclosure. FIG. 2 is a block diagram illustrating a detailed configuration of the virtual-gauge-based plant monitoring system. FIG. 3 is a block diagram illustrating a process of transmitting a measurement data packet to a non-secure area in the virtual-gauge-based plant monitoring system.

Referring to FIGS. 1 to 3, a virtual-gauge-based plant monitoring system 100 according to an embodiment of the present disclosure includes a photographing part 110, an image analysis part 120, a virtual gauge visualization part 130, and a monitoring part 140.

Herein, the virtual-gauge-based plant monitoring system 100 according to the embodiment of the present disclosure may be used for monitoring a plant 10 in which plant facilities 11 for manufacturing, assembly, storage, and management are built.

Herein, the above-described plant 10 means various plant institutions including a process plant, and in addition, may include institutions, such as national security institutions, national defense institutions, and smart factories, which need to be equipped with measurement devices, such as a gauge board, to monitor states or measurement values.

The photographing part 110 is installed at a plurality of locations inside the plant 10 and photographs at least one plant facility 11.

The photographing part 110 may transmit image data obtained by photographing a measurement device with which a plant facility 11 is equipped, to a supervisory server 20. Herein, the supervisory server 20 may be a server in a secure area built for supervising the inside of the plant 10.

In addition, the photographing part 110 may be CCTV pre-installed in the plant 10.

The image analysis part 120 uses image data of the secure area to generate a measurement data packet transmittable to a non-secure area.

The image analysis part 120 may be provided as the supervisory server 20 or realized as a program installed on the supervisory server 20.

In addition, the image analysis part 120 may receive image data, which is obtained by the photographing part 110, in real time or regular intervals, and may identify a measurement device of a plant facility 11 from the received image data to extract a measurement value, and may generate a measurement data packet including the extracted measurement value.

Specifically, when receiving image data, the image analysis part 120 may convert the image data to a hue saturation value (HSV) image, and may set a region of interest (ROI) on the basis of at least one structural feature selected from a group of the color, the pattern, the size, and the shape of the HSV image resulting from conversion, and may detect an object corresponding to a measurement device within the set region of interest.

In addition, the image analysis part 120 may compare an image of the detected object with a pre-stored feature image of the measurement device to identify the type of the measurement device, and may read the numbers or characters displayed on the measurement device on the basis of a character reading technology including an optical character reader (OCR) to extract a measurement value.

In addition, when the type of the measurement device is identified and the measurement value displayed on the measurement device is read, the image analysis part 120 may generate a measurement data packet by inserting identification information on the type of the measurement device and information on the measurement value.

Herein, the measurement data packet may be composed of a header area and a body area. In the header area, location information of the plant facility 11 or the photographing part 110 and the identification information of the measurement device may be inserted. In the body area, information on the time when the plant facility 11 is photographed and the information on the measurement value may be inserted.

In the meantime, a one-way data transmitter may be further provided to transmit a measurement data packet generated by the image analysis part 120 to the non-secure area.

Referring to FIG. 3, the one-way data transmitter may include DEVICE DRIVERS, DEVICE MANAGER, NETWORK POLICY, NETWORK LOG, and NETWORK INTERFACE ADAPTOR.

Specifically, in a transmission server (SSSS TX Sever), that is, the supervisory server 20, located in the secure area, DEVICE DRIVERS A to C may collect data for different devices A, B, and C by using protocols suitable for the respective devices. Herein, the fact that DEVICE DRIVERS are separately marked as A, B, and C means that data collection target devices are different devices and use different protocols. That is, depending on the configuration of the actual field environment, the types or number of devices may increase.

Afterward, the DEVICE MANAGER forwards data received from the DEVICE DRIVERs to the NETWORK POLICY, and the NETWORK POLICY inspects packets collected according to a network policy configured by the manager. When the packets are allowed, the packets are transmitted to the non-secure area, otherwise the packets are blocked. In addition, the NETWORK POLICY may record details of being transmitted or blocked on the NETWORK LOG. In addition, secure data allowed by the NETWORK POLICY to be transmitted may be encrypted and transmitted to the NETWORK INTERFACE ADAPTOR (Tx LAN card).

Afterward, a reception server (SSSS RX Sever), that is, NETWORK INTERFACE ADAPTOR (Rx LAN card) of the monitoring server 30, located in the secure area decrypts the received secure data and checks whether the secure data is transmitted from the transmission server (SSSS TX Sever) or the secure data is forged or falsified. As a result of checking, when the packet is not transmitted from the transmission server (SSSS TX Server) or forged falsified, the packet is blocked. When the packet is transmitted from the transmission server (SSSS TX Server) and is not forged falsified, the secure data is transmitted to CHANNEL MANAGER.

Then, the CHANNEL MANAGER may transmit the received data to the determined destination, and CHANNEL DRIVERs A to C may receive data for different destinations by using protocols suitable for the respective destinations.

In the meantime, the one-way data transmitter may further include, as a software management system for managing software: a security policy setting part that provides a screen UI so that security policies for the secure area are set and added, modified, or deleted; a security policy display part that outputs, on a screen UI, a list of security policies set in the security policy setting part; a packet log display part that outputs, on a screen UI, a log of a packet allowed or blocked according to the set security policies; and a one-way protocol setting part that provides a screen UI so that the security policy setting part sets a protocol for allowing one-way transmission.

The one-way data transmitter and the software management system thereof enable a manager to configure security policies for a communication interface section between the secure area and the non-secure area, and provide records of network packets allowed or blocked according to the set security policies, so that secure data is securely transmitted between heterogeneous systems.

The virtual gauge visualization part 130 visualizes a virtual gauge to display a measurement value.

The virtual gauge visualization part 130 may be provided as the monitoring server 30 or realized as a program installed on the monitoring server 30. A virtual gauge and a measurement value visualized by the monitoring server 30 may be displayed on a manager terminal 40.

Herein, the monitoring server 30 may be provided in an all-source situation room where the plant facilities 11 are monitored or selective control is performed, and may also be a server in the non-secure area where image data of CCTV is not transmitted or linked according to the security policies. The manager terminal 40 may be a general-purpose communication terminal including a personal computer, or a terminal device for displaying information in association with a plurality of display devices.

In addition, the virtual gauge visualisation part 130 in the non-secure area receives a measurement data packet composed of a numerical value and data, and visualizes, on the basis of the received measurement data packet, a virtual gauge corresponding to a measurement device of a plant facility 11, and displays a measurement value in real time on the visualized virtual gauge.

In addition, the virtual gauge visualisation part 130 identifies the type of the measurement device on the basis of the identification information included in the measurement data packet, and loads and visualizes a 3D model corresponding to the identified measurement device as a virtual gauge.

To this end, in the virtual gauge visualization part 130 or a memory, virtual gauges realized as 3D models corresponding to types of measurement devices may be pe-stored.

In addition, each time a measurement data packet is received and a measurement value is updated, the virtual gauge visualization part 130 changes a pointer on a virtual gauge and an object corresponding to a gauge board to locations or numerical values according to the measurement value of the measurement data packet, and displays the locations or the numerical values.

That is, similarly to a measurement value changed in a measurement device of an actual plant facility 11, the virtual gauge visualisation part 130 updates the manager terminal 40 on a pointer on a virtual gauge or a gauge board, so that a manager who monitors the virtual gauge may check the state of the plant facility 11 or the measurement value in real time.

The monitoring part 140 monitors a measurement value displayed on a virtual gauge, and outputs an alarm when the measurement value is out of a preset normal range.

In the monitoring part 140, information on a normal range of states or measurement values for each plant facility 11 may be pre-stored, and the monitoring part 140 may further include an output device for outputting an alarm.

In addition, when an alarm is output, the monitoring part 140 may request the virtual gauge visualisation part 130 to display an effect on a virtual gauge or to output a notification for informing of a dangerous situation.

In addition, the monitoring part 140 may be in conjunction with a control device of each plant facility 11 to stop the operation of a plant facility 11 out of a normal range or to adjust the operating state.

Hereinafter, described will be a virtual-gauge-based plant monitoring method performed in a virtual-gauge-based plant monitoring system according to an embodiment of the present disclosure.

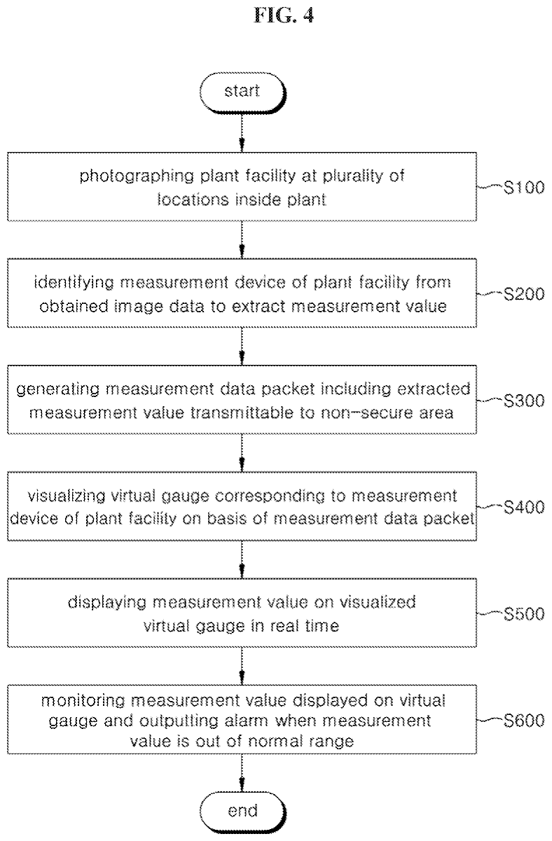

FIG. 4 is a diagram illustrating a virtual-gauge-based plant monitoring method according to an embodiment of the present disclosure.

However, all functions performed in the virtual-gauge-based plant monitoring method shown in FIG. 4 are performed in the virtual-gauge-based plant monitoring system described with reference to FIGS. 1 to 3. Therefore, it is noted that without explicit description, all functions described with reference to FIGS. 1 to 3 are performed in a virtual-gauge-based plant monitoring method according to a preferred embodiment of the present disclosure, and all functions described with reference to FIG. 4 are performed in a virtual-gauge-based plant monitoring system according to a preferred embodiment of the present disclosure as they are.

Referring to FIG. 4, in a virtual-gauge-based plant monitoring system 100 according to an embodiment of the present disclosure, first, at least one plant facility 11 at a plurality of locations in a plant 10 is photographed in step S100.

Step S100 may be performed by CCTV pre-installed in the plant 10, and image data obtained by photographing a measurement device provided in the plant facility 11 may be transmitted to a supervisory server 20. Herein, the supervisory server 20 may be a server in a secure area built for supervising the inside of the plant 10.

Next, an image analysis part 120 receives the image data obtained by a photographing part 110, and identifies a measurement device of the plant facility 11 from the received image data to extract a measurement value in step S200.

The image analysis part 120 in step S200 may be provided as the supervisory server 20 or realized as a program installed on the supervisory server 20, and the supervisory server 20 may be the server in the secure area built for supervising the inside of the plant 10.

In step S200, the image analysis part 120 may convert the image data to a hue saturation value (HSV) image, and may set a region of interest (ROI) on the basis of at least one structural feature selected from a group of a color, a pattern, a size, and a shape of the HSV image resulting from conversion, and may detect an object corresponding to a measurement device within the set region of interest.

In addition, in step S200, the image analysis part 120 may identify, from an image of the detected object, the type of the measurement device and may extract a measurement value. For example, the type of the measurement device may be identified by comparing the image of the detected object and a pre-stored feature image of the measurement device, and numbers or characters displayed on the measurement device may be read on the basis of a character reading technology including an optical character reader (OCR) to extract the measurement value.

Next, the image analysis part 120 generates a measurement data packet that includes the extracted measurement value and is transmittable to a non-secure area in step S300.

In step S300, when the type of the measurement device and the measurement value are extracted from the image of the detected object, the image analysis part 120 may generate a measurement data packet and may insert identification information on the type of the measurement device and information on the measurement value.

Herein, the measurement data packet has: a header area into which location information of the plant facility 11 or the photographing part 110 and the identification information of the measurement device are inserted; and a body area into which information on the time when the plant facility 11 is photographed and the information on the measurement value are inserted.

In addition, the image analysis part 120 may transmit the generated measurement data packet to a virtual gauge visualization part 130 located in the non-secure area or a server in which the virtual gauge visualization part 130 is installed. The transmission of the measurement data packet may be performed by a one-way data transmitter.

Next, the virtual gauge visualisation part 130 in the non-secure area receives the measurement data packet, and visualizes, on the basis of the measurement data packet, a virtual gauge corresponding to the measurement device of the plant facility 11 in step S400.

The virtual gauge visualisation part 130 in step S400 may be provided as a monitoring server 30 or realized as a program installed on the monitoring server 30. The monitoring server 30 may be a server that monitors plant facilities 11 or performs selective control, and in particular, may be a server in the non-secure area where image data of CCTV is not transmitted or linked according to security policies.

In step S400, the virtual gauge visualization part 130 may identify the type of the measurement device on the basis of the identification information included in the measurement data packet, and may load and visualize a 3D model corresponding to the identified measurement device as a virtual gauge. To this end, virtual gauges realized as 3D models corresponding to types of measurement devices may be pre-stored.

Next, the virtual gauge visualisation part 130 displays the measurement value on the visualized virtual gauge in real time in step S500.

In step S500, each time a measurement data packet is received and a measurement value is updated, the virtual gauge visualisation part 130 may change a pointer on a virtual gauge and an object corresponding to a gauge board to locations or numerical values according to the measurement value of the measurement data packet, and may display the locations or the numerical values.

Herein, the visualized virtual gauge and measurement value may be displayed on a screen of a manager terminal 40. Similarly to a measurement value changed in a measurement device of an actual plant facility 11, the pointer on the virtual gauge or the numerical value of the gauge board may be updated.

Next, the monitoring part 140 monitors the measurement value displayed on the virtual gauge and outputs an alarm when the measurement value is out of a preset normal range in step S600.

The monitoring part 140 in step S600 may be provided in the monitoring server 30 or may be realized as a program installed on the monitoring server 30.

In step S600, the monitoring part 140 may monitor the measurement value on the basis of information on a normal range of measurement values pre-stored for each plant facility 11, and may make a request that when the alarm is output, the virtual gauge displays an effect or a notification for informing of a dangerous situation is output.

In the meantime, in step S600, in conjunction with a control device of each plant facility 11, the operation of a plant facility 11 out of a normal range may be stopped or the operating state may be adjusted.

Although certain embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. A virtual-gauge-based plant monitoring system, comprising:
a photographing part provided at a plurality of locations inside a plant and configured to photograph at least one plant facility;
an image analysis part configured to receive image data obtained by the photographing part, identify a measurement device of the plant facility from the received image data to extract a measurement value, and generate a measurement data packet transmittable to a non-secure area, the measurement data packet including the extracted measurement value; and
a virtual gauge visualization part configured to receive the measurement data packet in the non-secure area, visualize a virtual gauge corresponding to the measurement device of the plant facility on the basis of the measurement data packet, and display the measurement value in real time on the visualized virtual gauge.

2. The system of claim 1, further comprising:
a monitoring part configured to monitor the measurement value displayed on the virtual gauge and output an alarm when the measurement value is out of a preset normal range.

3. The system of claim 1, wherein the image analysis part is configured to:
convert the image data to a hue saturation value (HSV) image, set a region of interest (ROI) on the basis of at least one structural feature selected from a group of a color, a pattern, a size, and a shape, and
detect an object corresponding to the measurement device within the region of interest.

4. The system of claim 1, wherein the image analysis part is configured to:
identify a type of the measurement device from an image of a detected object to extract the measurement value, and
insert identification information on the type of the measurement device and information on the measurement value in generating the measurement data packet.

5. The system of claim 1, wherein the virtual gauge visualisation part is configured to:
identify a type of the measurement device on the basis of identification information included in the measurement data packet, and
load and visualize a 3D model corresponding to the identified measurement device as the virtual gauge.

6. The system of claim 1, wherein the virtual gauge visualisation part is configured to:
change, each time the measurement data packet is received and the measurement value is updated, a pointer on the virtual gauge and an object corresponding to a gauge board to locations or numerical values according to the measurement value of the measurement data packet, and
display the locations or the numerical values.

7. The system of claim 1, wherein in the measurement data packet, location information of the plant facility or the photographing part and identification information of the measurement device are inserted in a header area, and information on time when the plant facility is photographed and information on the measurement value are inserted in a body area.

8. A virtual-gauge-based plant monitoring method performed in a virtual-gauge-based plant monitoring system, the method comprising the steps of:
photographing, in a photographing step, at least one plant facility at a plurality of locations inside a plant;
receiving, in an extracting step, image data obtained by performing photographing, and identifying a measurement device of the plant facility from the received image data to extract a measurement value;
generating, in a packet generating step, a measurement data packet transmittable to a non-secure area, the measurement data packet including the extracted measurement value;
receiving, in a visualizing step, the measurement data packet in the non-secure area, and visualizing a virtual gauge corresponding to the measurement device of the plant facility on the basis of the measurement data packet; and
displaying, in a measurement value displaying step, the measurement value on the visualized virtual gauge in real time.

9. The method of claim 8, further comprising a step of:
monitoring, in a monitoring step, the measurement value displayed on the virtual gauge and outputting an alarm when the measurement value is out of a preset normal range.

10. The method of claim 8, wherein in the extracting step, the image data is converted to a Hue Saturation Value (HSV) image, and a region of interest (ROI) is set on the basis of at least one structural feature selected from a group of a color, a pattern, a size, and a shape, and an object corresponding to the measurement device is detected within the region of interest.

11. The method of claim 8, wherein in the packet generating step, when a type of the measurement device and the measurement value are extracted from an image of a detected object, identification information on the type of the measurement device and information on the measurement value are inserted in generating the measurement data packet.

12. The method of claim 8, wherein in the visualizing step, a type of the measurement device is identified on the basis of identification information included in the measurement data packet, and a 3D model corresponding to the identified measurement device is loaded and visualized as the virtual gauge.

13. The method of claim 8, wherein in the measurement value displaying step, each time the measurement data packet is received and the measurement value is updated, a pointer on the virtual gauge and an object corresponding to a gauge board are changed to locations or numerical values according to the measurement value of the measurement data packet and the locations or the numerical values are displayed.

14. The method of claim 8, wherein in the measurement data packet, location information of the plant facility or the photographing part and identification information of the measurement device are inserted in a header area, and information on time when the plant facility is photographed and information on the measurement value are inserted in a body area.
